(19) United States
(12) Patent Application Publication
(10) Pub. No.: US 2010/0063919 A1
(43) Pub. Date: Mar. 11, 2010

(54) TRADING STYLE AUTOMATED ANALYSIS AND REVERSE ENGINEERING

(76) Inventor: Richard Kane, Lake Worth, FL (US)

Correspondence Address: Richard Kane, 6524 Marbletree Lane, Lake Worth, FL, 33467, US

(21) Appl. No.: 12/312,101

(22) PCT Filed: Oct. 23, 2006
(86) PCT No.: PCT/US2006/041204

§ 371 Date: Apr. 23, 2009

(51) Int. Cl. G06Q 40/00

(52) U.S. Cl. 705/37

(57) ABSTRACT

A trading style reverse engineering system capable of learning specific trading styles by automated analysis and reverse engineering comprising: a data acquisition system having an input communicating with a securities exchange and various market news sources for receiving buy/sell data and market news data; an order and execution import module having an input communicating with model trader's trading interface for acquiring model trader order and execution data; a clock for generating clock times; a decision logic having a repository for storing a set of buy/sell rules for buying and selling securities in response to said buy/sell data, said market news data, and said order and execution data with said clock times; a knowledge database having inputs for receiving data from said order and execution import module, said data acquisition system, and said decision logic; a processing logic having inputs respectively communicating with said data acquisition systems, said order and execution module, and with said clock for assigning respective clock times to said market data and model trader data.

### FIELD OF INVENTION

The present invention pertains to a securities (the term “securities” is in the following to be understood to include “securities and/or commodities”) and commodities trading system that is capable of learning specific trading styles via analysis and reverse engineering. Such a system includes a computer communicating with a securities exchange, various sources of market data, and has inputs for receiving buy/sell data from a particular model trader(s) (the term “trader” is in the following to be understood to include both human traders and automated program trading systems). The computer program is capable of evaluating the orders and executions of a trader that the system has received for a given time period against the market data recorded for the same time period and issuing buy/sell orders in accordance with a plurality of buy/sell rules, known as agents. A feedback arrangement monitors the success or failure of the respective buy/sell agents and assigns cumulative weighting merits. This process implements a learning process for gradually aligning the system performance to the desired trading style based on past model trader performance and the agents' cumulative experience.

### BACKGROUND OF THE INVENTION

Human and automated trading programs have unique trading styles and triggers, and may not possess the self knowledge to understand those trading styles. Some of the best human traders trade by intuition, driven by diverse market data points. However, they trade within a narrow margin bounded by fear and greed, and their performance is uneven and subject to large variations in direct proportion to their desperation. Trading “personalities” are also market specific, and very few traders perform well across all market variations. The intense focus required by the best traders is both mentally and physically exhausting, and many traders only trade for a few minutes or hours per day, whereas trading across global markets presents a 24/7 opportunity.

An automated program trading system, on the other hand, is impervious to the fear, greed, desperation, and exhaustion to which human traders are susceptible. An automated system can patiently wait for and act on an opportunity without hesitation. It can also mitigate risks through strict adherence to both hedging strategies and automated protections and can exit an unsuccessful position without the emotional reservations of human traders.

It is known in the art to use a system of software trained rules as decision making agents for trading securities. U.S. Pat. No. 6,317,728, also by the present inventor, discloses a system in which a computer communicates with a securities exchange and has inputs for receiving buy/sell data. The system evaluates the buy/sell data and issues buy/sell orders in accordance with a plurality of buy/sell agents. A feedback arrangement monitors the success or failure of each decision based upon a current assets memory and assigns cumulative weighting merits to successful agents. Gradually, the system learns to trade in such a manner to continually increase the current assets memory based on the continuously accumulating experience of the agents.

The majority of the current state of the art focuses on keeping human traders in control of their holdings by continually calculating the risk of a held portfolio and the amount of trading capital. Additionally, it is speculated that the Securities and Exchange Commission may have software programs in place to monitor for suspicious or abnormal trading activity based on trades front-running changes or news in individual securities. However, the present inventor is not aware of any other invention which is capable of reverse engineering trading styles. Furthermore, the object of this invention is not for the trading system to learn to be profitable, but for it to learn how to trade like another trader, regardless of profitability.

Successful human traders view their trading style as highly proprietary information. Trading firms that utilize human traders vie to retain their superior performers and do not ask them to reveal their trading styles. However, an individual trader's trade execution information is property of the clearing firm. With the aid of this invention, the firm can use that trade execution data to reverse engineer the trading styles and portfolio management triggers of their most successful traders. In doing so, firms can effectively duplicate their top performing traders and increase their overall returns.

The present invention is directed to a process that satisfies the need to reverse engineer trading styles. Trading and clearing firms will often employ some exceptional human “model traders” that are their top performers across a variety of market conditions. This invention allows a firm to reverse engineer and duplicate a model trader's trading style by teaching that style to an automated trading system.

In accordance with an embodiment of the invention, there is provided an automated securities trading analysis system having a data acquisition system having an input communicating with a securities exchange for receiving buy/sell data and market news (such as analyst ratings, forecasts, earnings, etc.); an order and execution import module having an input communicating with the model trader's trading interface to receive buy/sell data; a clock for generating clock times, a processing logic having inputs respectively communicating with said data acquisition system, order and execution import module, and clock for assigning respective clock times to market buy/sell data, market news, and model trader buy/sell data; a decision logic having a repository for storing a set of buy/sell rules for buying and selling securities in response to market buy/sell data, market news, and model trader order and execution data; and a buy and sell execution system having an input communicating with the decision logic for executing buy and sell orders in conformance with the buy/sell rules. The execution system may also have an output communicating with a trade simulation module.

In accordance with an embodiment of the invention, a trading analysis system has a decision logic comprising at least one decision agent, the agent representing a respective buy/sell rule, wherein the decision logic may further include at least two decision agents, each decision agent representing a respective buy rule or sell rule.

According to a further feature, the automated security trading analysis provides that the sell rule is a short sell rule and the buy rule is a long buy rule, and the decision logic includes at least one agent being responsive to one of the buy/sell rules, that agent being operative for generating a buy/sell order in response to the buy/sell data conforming to the buy/sell rule.

In accordance with an embodiment of the invention, an automated securities trading analysis system according to the invention may further include a plurality of agents, each agent operating in response to a dedicated set of the buy/sell rules, and wherein each of the agents has a common respective input for receiving market buy/sell data, market news, and model trader order and execution data.

Another feature of an automated securities trading analysis system, in accordance with an embodiment of the invention, is a knowledge database having inputs communicating with the decision logic, the market data recorder, and the order and import execution recorder. The knowledge database features a feedback connection to each of the agents for conveying a cumulative number of merit points to a respective agent having issued a sell order for a successful trade in which success is measured by conformance to the model trader data under similar market conditions. In accordance with an embodiment of the invention, an automated securities trading analysis system may also include a current assets memory for the purposes of a certainty check in which an order can only be carried out if there are sufficient assets.

In accordance with an embodiment of the invention, a trading analysis system further includes a method for automated analysis and reverse engineering of specific trading styles, the method including a data acquisition system having an input communicating with at least one securities exchange for receiving buy/sell data and market news (such as analyst ratings, forecasts, earnings, etc.); an order and execution import module having an input communicating with the model trader's trading interface to receive buy/sell data; a clock for generating clock times, a processing logic having inputs respectively communicating with data acquisition system, order and execution import module, and clock for assigning respective clock times to market buy/sell data, market news, and model trader buy/sell data; a decision logic having a repository for storing a set of buy/sell rules for buying and selling securities in response to market buy/sell data, market news, and model trader order and execution data; the decision logic having a plurality of agents each operating in response to a respective buy/sell rule for generating buy/sell orders for securities in conformance with buy/sell data, market news, and model trader order and execution data; and a buy and sell execution system having an input communicating with the decision logic for executing buy and sell orders in conformance with the buy/sell rules, where said execution system may also have an output communicating with a trade simulation module. In accordance with an embodiment of the invention, the method may comprise the following steps:

(a) Issuing to all the agents a tentative buy short/sell long order for a given security;

(b) Soliciting from all the agents a tentative buy short decision for the given security;

(c) Affirming with the decision logic the buy short decision if a majority of the agents have indicated an affirmative buy short decision;

(d) Executing with an executing logic the affirmed buy short order;

(e) Monitoring the agents to and feeding back success or failure and rewarding or punishing the agents accordingly.

According to an embodiment of the invention, the method may further include a human component in which a human inputs breaking news and other market force factors not readily attainable through a market data stream feed. The method may also use a specialized data feed for acquiring breaking data such as transactions by insiders within a company which may be a driving force on a security's trading price. Such a specialized data feed may require additional subscription costs.

In other embodiments of the invention, the method may also employ purchasing or subscribing to the New York Stock Exchange's Trade and Quote (“TAQ”) database. This offers an advantage of perfect hindsight whereas with recording live data, the operator must know in advance which markets and products are intended to be traded. The TAQ data may also be used in conjunction with historical model trader data and the trade simulation module to teach the system by allowing the agents to accumulate weighted merits before interfacing the system to a live securities exchange.

### SUMMARY

A trading style reverse engineering system capable of learning specific trading styles by automated analysis and reverse engineering comprising: a data acquisition system having an input communicating with a securities exchange and various market news sources for receiving buy/sell data and market news data; an order and execution import module having an input communicating with model trader's trading interface for acquiring model trader order and execution data; a clock for generating clock times; a decision logic having a repository for storing a set of buy/sell rules for buying and selling securities in response to said buy/sell data, said market news data, and said order and execution data with said clock times; a knowledge database having inputs for receiving data from said order and execution import module, said data acquisition system, and said decision logic; a processing logic having inputs respectively communicating with said data acquisition systems, said order and execution module, and with said clock for assigning respective clock times to said market data and model trader data.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is a block diagram of the major components of the invention, showing hardware and software components and their mutual lines of interaction, in accordance with an embodiment of the invention.

FIG. 2 shows the basic steps used in practicing the invention, in accordance with an embodiment of the invention.

FIG. 3 shows a high level flow chart of the major steps of a typical transaction, in accordance with an embodiment of the invention.

FIG. 4 shows a block diagram of the typical embodiment of the invention and how the major function blocks interface with the automatic trading style analysis system.

FIG. 5 is a flow chart showing the major steps of the evaluation procedure with artificial intelligence and evaluation criteria, in accordance with an embodiment of the invention.

FIG. 6 is a flow chart for the major steps in the procedure for evaluating the agents, in accordance with an embodiment of the invention.

FIG. 7 is a flow chart showing the major steps for making hold/sell decisions, in accordance with an embodiment of the invention.

FIG. 8 is a flow chart depicting how the system learns from a successful long order transaction, in accordance with an embodiment of the invention.

FIG. 9 is a flow chart depicting how the system learns from a successful short order transaction, in accordance with an embodiment of the invention.

FIG. 10 is a flow chart depicting how the system learns from a failed long order transaction, in accordance with an embodiment of the invention.

FIG. 11 is a flow chart depicting how the system learns from a failed short order transaction, in accordance with an embodiment of the invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

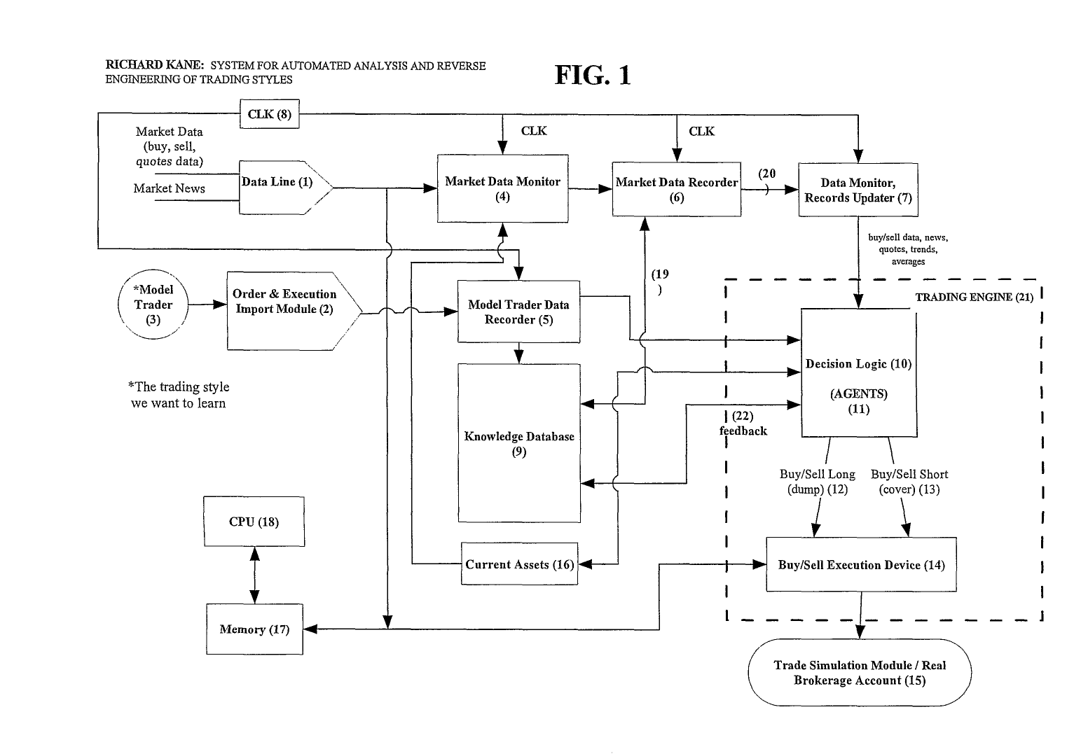

FIG. 1 depicts the major components of an embodiment of the invention, showing hardware and software components and their mutual lines of interaction; wherein an executing device 10 is connected by respective “buy long” and “sell short” data channels 12, 13 to a Decision Logic 10 comprising a plurality of “agents” 11.

Each agent exists as a module or section of computer logic, physically stored in computer memory 17, which is connected with and controlled by a central processing unit (CPU) 18. Each agent 11 performs a respective buy or sell decision based on a set of rules embedded in each agent. All agents represent different buy/sell rules, and all continuously receive the movements and news of the securities markets in general as received from conventional ticker tape data and other market news sources being issued as a data stream from the various securities and/or commodities markets, being received on a data line 1 connected via conventional data transmission facilities from securities and/or commodities markets. Agents also receive continuously the trade execution data from the model trader by an order and execution import module 2.

The news and ticker tape data as they arrive in continuous streams are extracted by the market data monitor 4 which retains only data that pertain to specific securities and/or commodities stored in the system's current assets memory 16, connected via data line 19 to the market data monitor 4. All relevant market data are organized and stored in the Market Data Recorder 6, and periodically examined under control of a Clock 8.

The order and execution data of the model trader 3 are sent to the model trader data recorder 5 via means of the Order and Execution Import Module 2.

A Data Monitor and Record Change Unit 7 keeps a running record of all periodically recorded data from the market data recorder by data line 20, and processes the data in accordance with a certain set of general rules pertaining to all securities and for commodities in inventory.

The Trading Engine 21 comprises a Decision Logic 10, a Buy/Sell Execution Device 14, and a number of atomic trading rules, each encapsulated in a script. A base installation has 100 trading rules, and the ability to script additional rules. In learning/training mode, these trading rules are recombined to form every possible combination, 100 deep. These combinations are termed “agents” 11. The Decision Logic 10 comprises a plurality of agents which may collectively issue buy/sell suggestions for securities transactions as they may pertain to one security transaction at a time. A decision to buy or sell a respective security is made by each agent according to the rules embedded in each agent. Generally, a tentative buy or sell order is issued and all agents make a recommendation as to the disposition of the respective security and an accounting is taken of all decisions of the respective agents by a voting algorithm contained within the Decision Logic 10. The result of the vote is transmitted by either the “buy long” data channel 12 or the “sell short” data channel 13, and the decision is executed in the Execution Device 14 which transmits the order to either a brokerage account or a Trade Simulation Module 15 designed to simulate a connection to a brokerage account type mechanism.

As a result of the execution of each trade, values for respective securities are adjusted in the Current Assets Memory 16. The adjustment may be positive or negative depending on if the transaction resulted in a loss or gain of assets. The decision from the Decision Logic is also sent to the Knowledge Database 9. The Knowledge Database 9 keeps track of clocked market data from the Market Data Recorder 6, order and execution data from the Model Trader Data Recorder 5, and decisions made by the Decision Logic 10. The success or failure of a trade is determined in the Knowledge Database 9 by means of decisional logic comparing the model trader's order and execution data and the market data for the same time period to the Decision Logic's 10 decision. If the decision conforms to the behavior exhibited by the model trader 3 within defined parameters, then the transaction is viewed as a success. Otherwise, the transaction is a failure, regardless of whether or not current assets increased. The success/failure determination is fed back into the Decision Logic 10 via a data line 22 as a score to be accumulated in each agent 11 in a merit memory. Each agent 11 has a dedicated merit memory. In each agent 11, voting power is weighted by the accumulated score. As a result, agents 11 accumulating higher scores attain increased voting power over time so that agents 11 that provide better decisions will eventually exert more influence on the overall system's performance. Thus, the system undergoes a “learning process.”

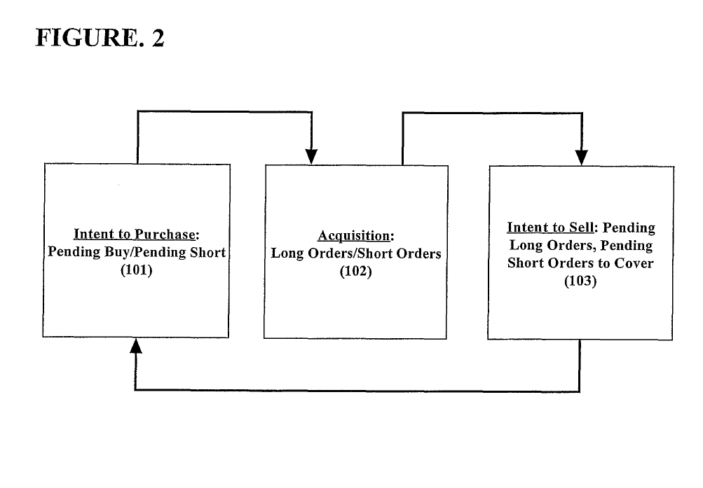

FIG. 2 is a simplified flow chart showing the three major steps in practicing an embodiment of the invention. There is initially an “Intent to Purchase 101” representing a pending buy or pending short transaction, which is followed by an “Acquisition” 102, which is in turn followed by an “Intent to Sell” 103, and followed again by “Intent to Purchase” 101, and so forth.

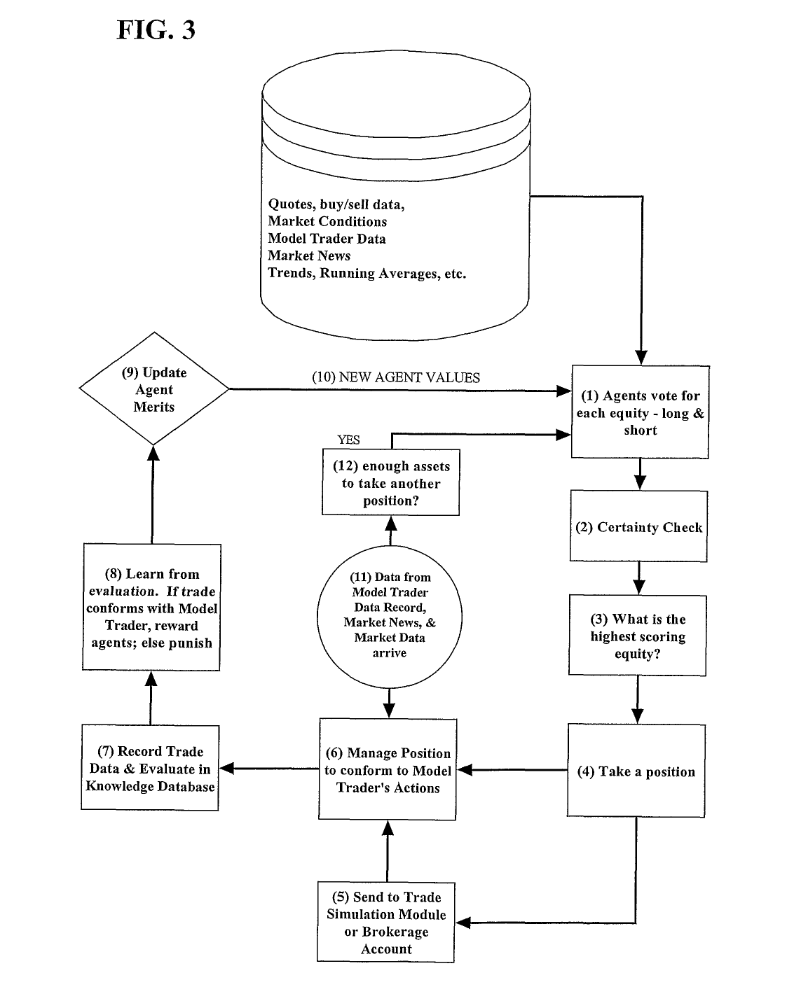

FIG. 3 shows a high level flow chart of the major steps of a typical transaction, in accordance with an embodiment of the invention.

(1) Agents

The agents in the system vote 1 based on rules and logic which evaluate market and specific equity behaviors in relation to the model trader order and execution data. Many of the agents are also controlled by system parameters. When an agent votes, the votes are added to the long or short votes for the tentative order. Agent values are continually updated after each success/failure evaluation as part of the learning process.

(2) Certainty Check

The system incorporates an additional check, after the agents have voted, that checks the certainty of the vote for each equity. Essentially, the system asks itself “is this what the model trader would do?”

(3) Voting

All equities that pass the certainty check and other checks are then compared to each other. The sum of the weighted long votes is compared to the sum of the weighted short votes. The security that has the greatest magnitude delta between the long and short votes is selected.

(4) Taking a Position

Once a security is selected either a buy or sell order is generated depending on the result of the vote.

(5) Executing the Trade

An order resulting from the Decision Logic can be executed by sending the order to either a Trade Simulation Module or a real brokerage account.

(6) Managing the Position

Once a position is taken the system manages the position in a manner conforming to the model trader behavior. The system is constantly receiving data from the model trader data recorder and market data recorder.

(7) Record Trade Data

Every trade the system makes is stored in the Knowledge Database for evaluation. The Knowledge database also stores the model trader's trading activity as well as market data and news.

(8) Learn from Evaluation

The result of each trade executed by the system is evaluated in the Knowledge Database. A successful trade results when the Knowledge Database determines that the system has executed a trade consistent with model trader behavior. Otherwise, the trade is marked as unsuccessful. The agents are rewarded or punished based on their votes.

(9) Agent Merits

Each agent has its own individual memory for storing merits. The merits accumulate over time and dictate the amount of voting power an agent has. Thus, a consistently successful agent will quickly gain influential voting power while a consistently unsuccessful agent will be marginalized.

(10) Updating Agent Values

Each time merits are updated, agents are re-weighted and the new weights are used in subsequent rounds of voting.

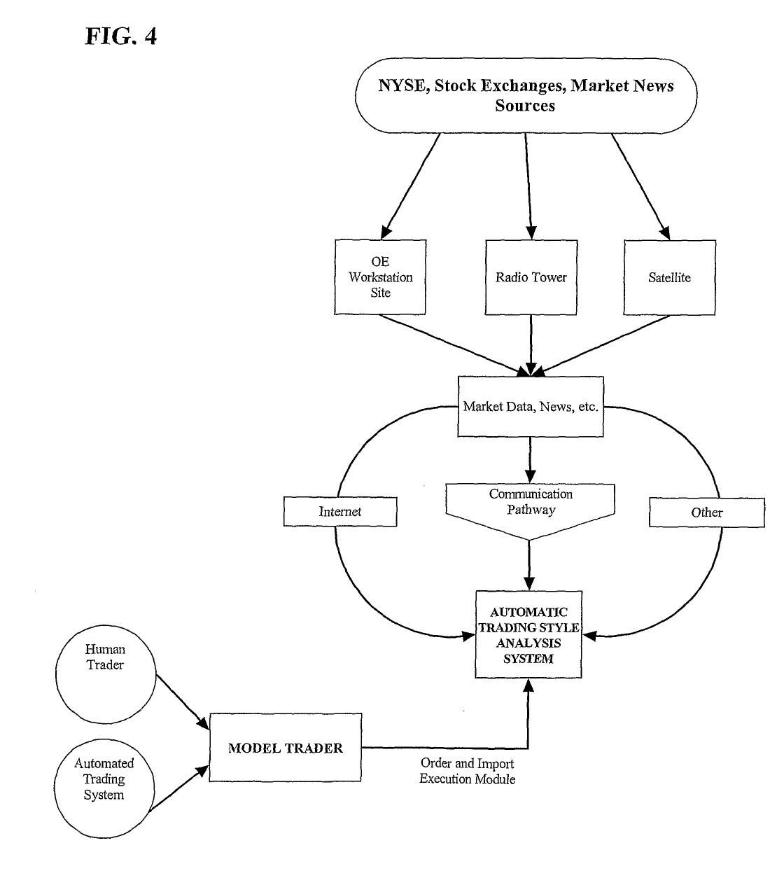

FIG. 4 shows the interface between the automated analysis system, the order and execution import module, and the various communication pathways, in accordance with an embodiment of the invention. The system receives model trader order and execution data via means of an order and execution import module. The model trader can be either a human trader, or an automated trading system. The order and execution import module simply collects the trade data and feeds it to the system. The system is also connected through various communication channels in order to receive market quotes, data, and news from the stock exchanges and relevant news sources.

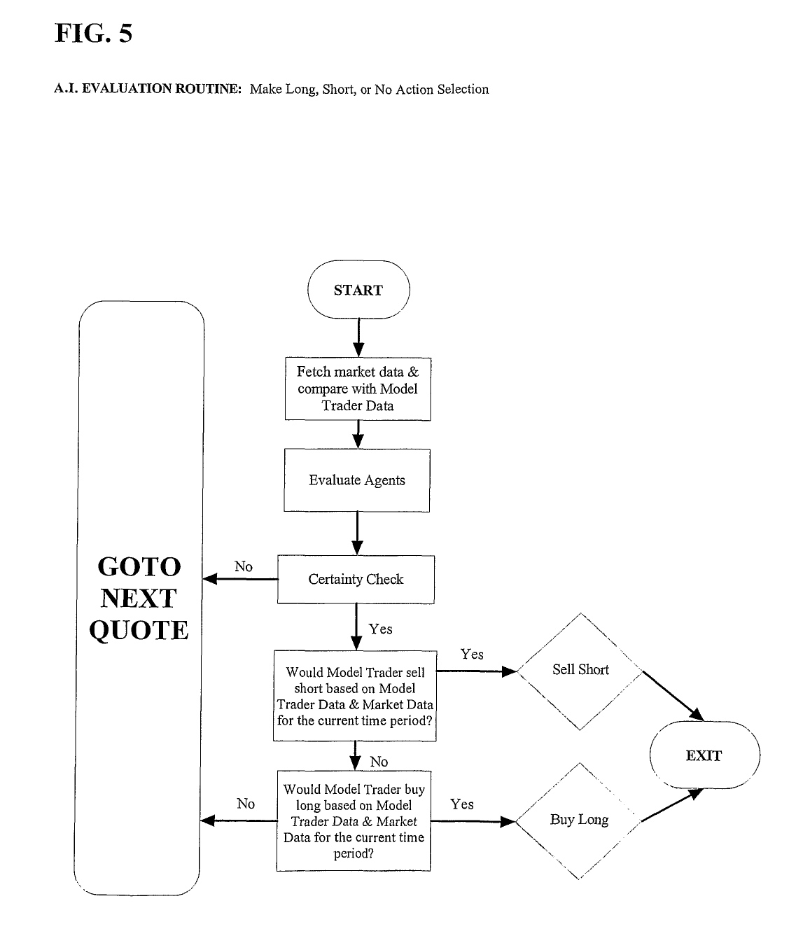

FIG. 5 illustrates the artificial intelligence voting that occurs selecting a security position, in accordance with an embodiment of the invention. Market data and model trader data are continuously summarized and stored in memory in real time. The information is then evaluated by each of the long and short agents and accordingly results in a buy, sell or do nothing action.

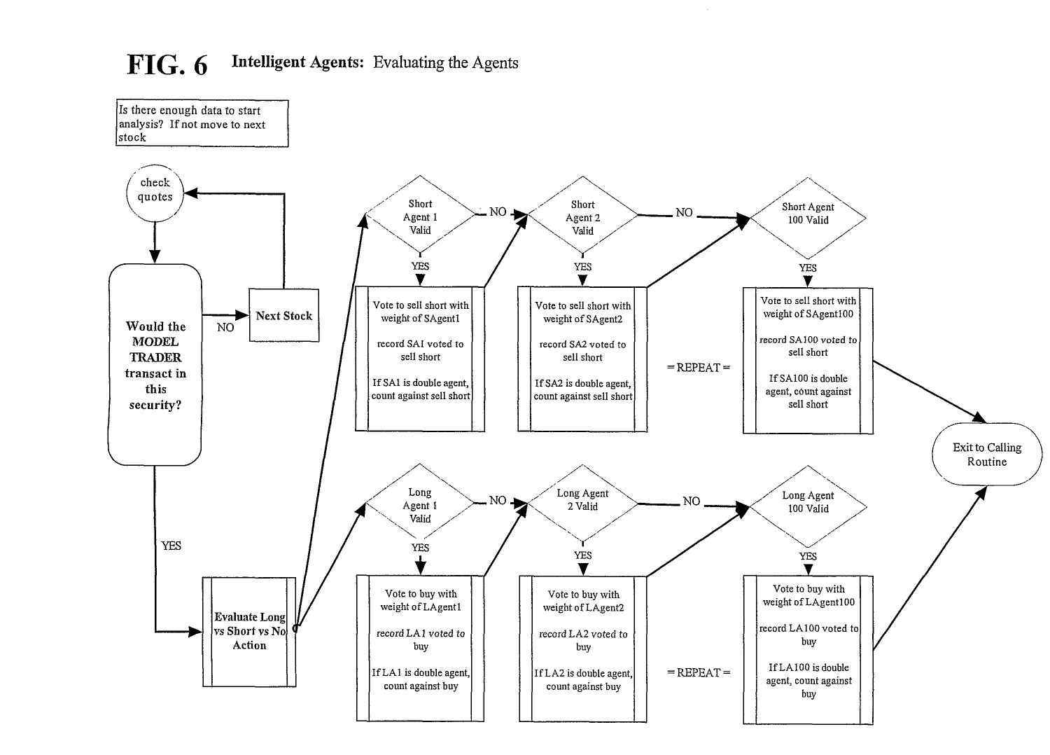

FIG. 6 illustrates how each security is evaluated prior to voting, in accordance with an embodiment of the invention. The criteria is whether or not the model trader would transact with the respective security. If the system determines that the model trader would not trade the particular security, the system moves on to the next quote. Otherwise, the agents are consulted for voting. Each long and short agent votes and the votes are tallied with the weight of the agent. If the agents weight is negative, it votes as a double agent (a short agent vote would count towards a long purchase and a long agent vote would count towards a short purchase). The agent's vote is also recorded in the Knowledge Database for learning and analysis. The process is repeated for each security and for each agent.

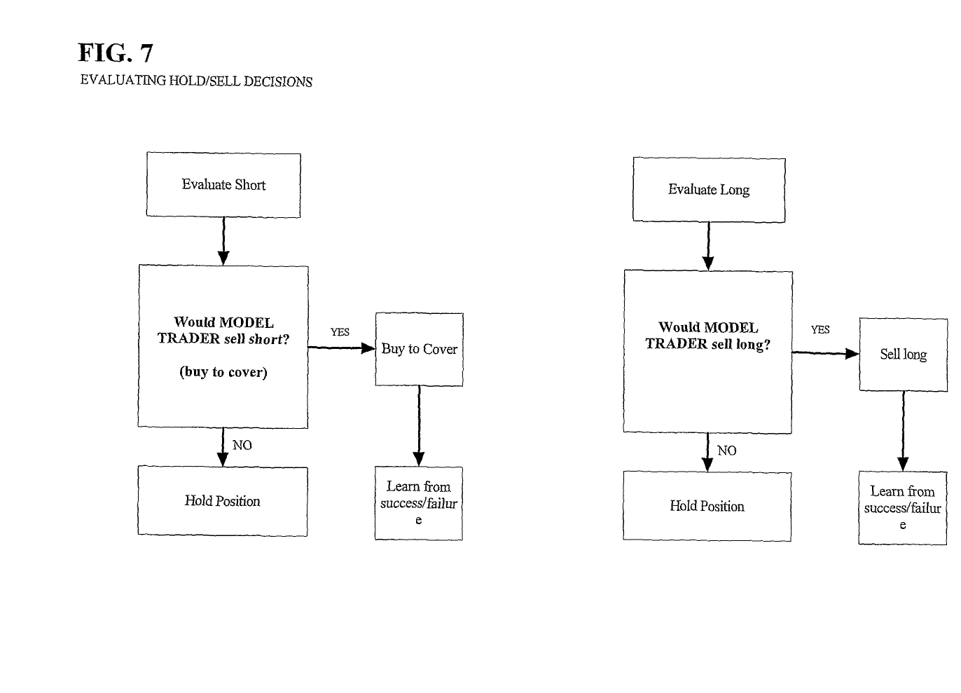

FIG. 7 shows how a hold or sell decision is evaluated and carried out, in accordance with an embodiment of the invention. If the position is a short position, the system determines whether the model trader would release the short position (buy to cover) based on the model trader data and the market data. If the system determines in the affirmative, a buy to cover order is executed. If the system determines that the model trader would not release the position, then the system will hold the position. If the position is a long position, the system determines whether the model trader would sell the position. If the system determines in the affirmative, a sell long order is executed. Otherwise, the system will hold the position. After either a buy to cover or sell long order is executed, the agents are rewarded or punished based on the transaction and whether their vote is consistent with the model trader's trading style.

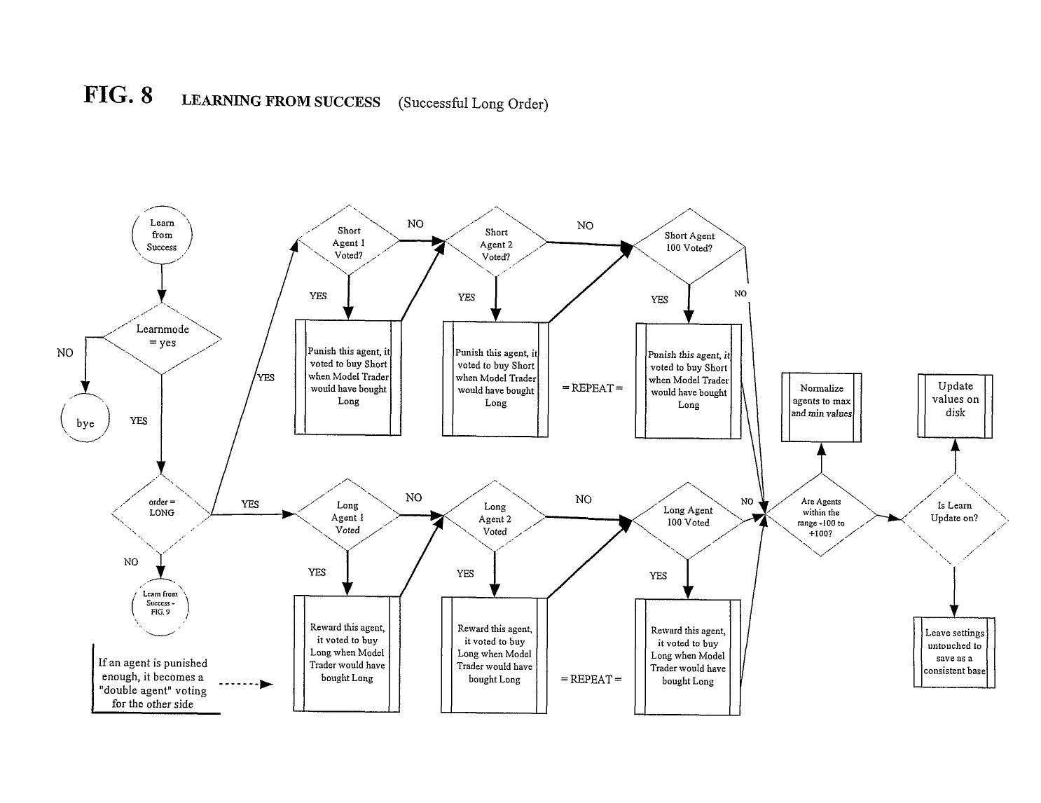

FIG. 8 shows the details of how agents are rewarded for a successful long order, in accordance with an embodiment of the invention. If the learnmode is engaged, and the order is a long order, and the order was successful, then the system performs the following steps:

(1) Any long agent that voted long for this order is rewarded. From the chart it is depicted as “Reward this agent, it voted to take a long position when the Knowledge Database (refer back to FIG. 1) shows that the model trader would have also done so.”

(2) Any short agent that voted against this long order is punished. From the chart: “Punish this agent, it voted to take a short position when the Knowledge Database (refer back to FIG. 1) shows that the model trader would have taken a long position.”

An important concept in this system is that agents that are consistently wrong are punished so often that they become double agents, voting for the other side. In this case, a long agent that continually votes against a short trade under certain market conditions and model trader data ends up with a negative value, such that when it votes to buy long, its negative value detracts from the total vote to buy long, therefore making a short order more likely. A second important concept is that non-predictive agents are automatically marginalized. Their accuracy levels drop so low that they disappear into background noise.

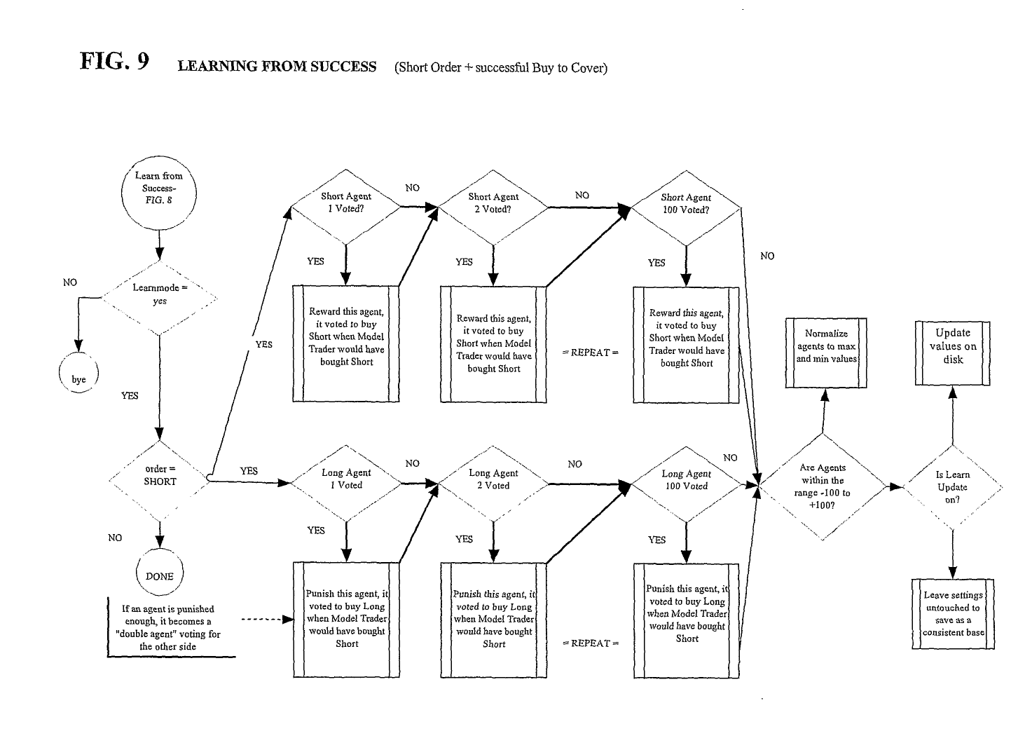

FIG. 9 shows the details of how agents are rewarded for a successful short order, in accordance with an embodiment of the invention. If the learnmode is engaged, and the order is a short order, and the order was successful, then the system performs the following steps:

(1) Any short agent that voted short for this order is rewarded (gains a merit). From the chart it is depicted as “Reward this agent, it voted to take a short position when the Knowledge Database (refer back to FIG. 1) shows that the model trader would have also done so.

(2) Any long agent that voted against this short order is punished. From the chart: “Punish this agent, it voted to take a long position when the Knowledge Database (refer back to FIG. 1) shows that the model trader would have taken a short position.

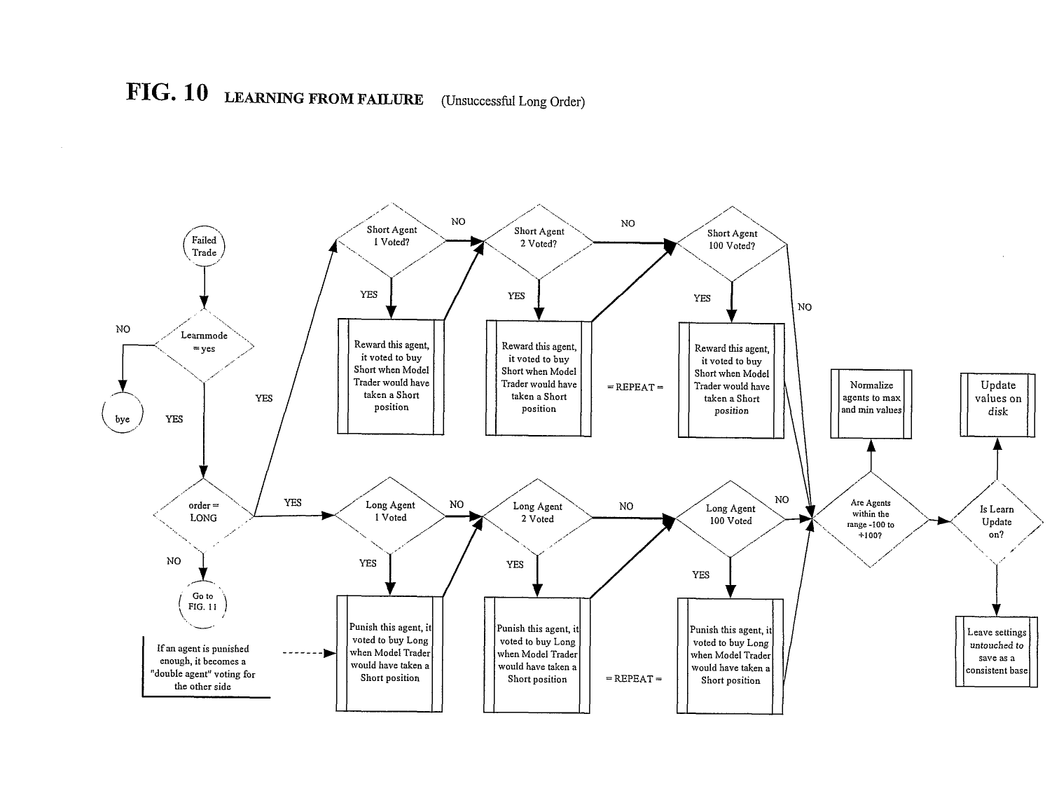

FIG. 10 shows the detail of how agents are punished for an unsuccessful long order, in accordance with an embodiment of the invention. If the learnmode is engaged, and the order is a long order, and the order was unsuccessful, then the system performs the following steps:

(1) Any long agent that voted long for this order is punished.

(2) Any short agent that voted against this long order is rewarded.

Again, an important concept of this system is that agents that are consistently wrong are punished so often that they become double agents, voting for the other side.

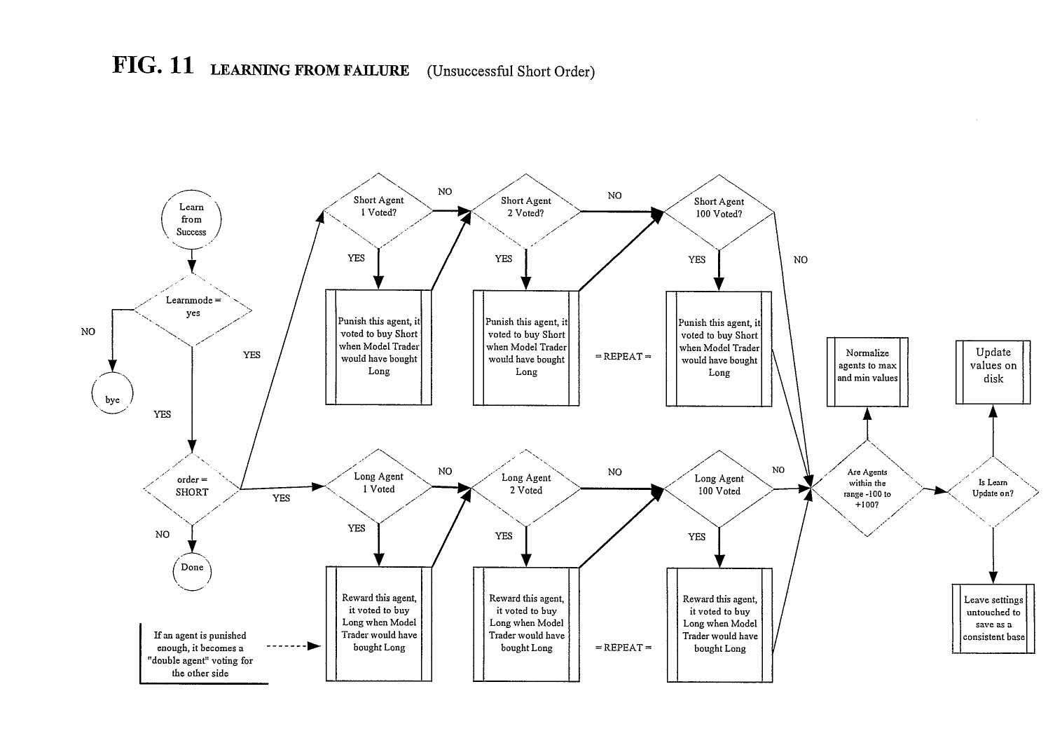

FIG. 11 shows the detail of how agents are punished for an unsuccessful short order, in accordance with an embodiment of the invention. If the learnmode is engaged, and the order is a short order, and the order was unsuccessful, then the system performs the following steps:

(1) Any long agent that voted long for this order is rewarded.

(2) Any short agent that voted against this long order is punished.

Again, an important concept of this system is that agents that are consistently wrong are punished so often that they become double agents, voting for the other side.

In the foregoing specification, embodiments of the invention have been described with reference to numerous specific details that may vary from implementation to implementation. Thus, the sole and exclusive indicator of what is the invention, and is intended by the applicant to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A trading style reverse engineering system capable of learning specific trading styles by automated analysis and reverse engineering comprising:
(1) a data acquisition system having an input communicating with a securities exchange and various market news sources for receiving securities buy/sell data and market news data;
(2) an order and execution import module having an input communicating with the model trader's trading interface for acquiring the model trader's order and execution (trading activity) data;
(3) a clock for generating clock times;
(4) a processing logic having inputs respectively communicating with said data acquisition systems, said order and execution module, and with said clock for assigning respective clock times to said market data and model trader data;
(5) a decision logic having a repository for storing a set of buy/sell rules for buying and selling securities in response to said buy and sell data, said market news data, and said model trader order and execution data with said clock times; and
(6) a knowledge database having inputs for receiving data from said order and execution import module, said data acquisition system, and said decision logic;

2. A securities trading system according to claim 1, further comprising:
(1) a current assets memory; and
(2) a buy and sell execution system having an input communicating with said decision logic for executing buy and sell orders in conformance with said buy/sell rules, wherein said decision logic contains at least one agent being responsive to one of the said buy/sell rules, said agent being operative for generating a buy/sell order in response to said buy/sell data conforming to said buy/sell rule, and a feed-back connection from said knowledge database to each of said agents for conveying a cumulative number of merits to a respective agent having issued an order for a successful trade.

3. A trading style reverse engineering system according to claim 1, wherein said decision logic has a learning algorithm capable of learning by means of a cumulative merit system, where said algorithm comprises a decision agent, said decision agent representing either a buy or a sell rule, and where said agent is rewarded for conforming trades or punished for non-conforming trades.

4. A method of automated analysis and reverse engineering of trading styles, the method including a data acquisition system having an input communicating with at least one securities exchange and other market news sources for receiving securities buy/sell data and market news data; an order and execution import module having an input communicating with the model trader's trading interface for the purpose of gathering the model trader's order and execution trading data; a clock for generating clock times; a processing logic having inputs for respectively communicating with said data acquisition systems, said order and execution module, and with said clock for assigning respective clock times to said market data and model trader data; a knowledge database having inputs for receiving data from said order and execution import module, said data acquisition system, and said decision logic; said decision logic including a repository for storing a plurality of buy/sell rules for buying and selling securities in response to said buy and sell data, said market news data, and said model trader order and execution data with said clock times; said decision logic having a plurality of agents, each assigned a respective buy/sell rule for generating buy/sell orders for securities in conformance with model trader behavior; said agents having outputs communicating with said securities exchange or a trade simulation module for executing said buy/sell orders, the method comprising the steps of
(a) issuing to all agents a tentative buy short/sell long order for a given security;
(b) soliciting from all agents a tentative buy short decision of a given security;
(c) affirming with the decision logic the buy short decision if a majority of the agents have indicated an affirmative buy short decision; and
(d) executing with an executing logic the affirmed buy short order including;
(i) monitoring for a given length of time the security bought on the buy short order;
(ii) issuing an order to release the security if said agents vote that the model trader would do so; and
(iii) monitoring for another given length of time with the decision logic the rates of success and failure of each agent and feeding back to each agent a cumulative merit quotient increment according to the cumulative rate of success and/or failure for the respective agent.

5. A method of automated analysis and reverse engineering of trading styles, the method including a data acquisition system having an input communicating with at least one securities exchange and other market news sources for receiving securities buy/sell data and market news data; an order and execution import module having an input communicating with the model trader's trading interface for the purpose of gathering the model trader's order and execution trading data; a clock for generating clock times; a processing logic having inputs for respectively communicating with said data acquisition systems, said order and execution module, and with said clock for assigning respective clock times to said market data and model trader data; a knowledge database having inputs for receiving data from said order and execution import module, said data acquisition system, and said decision logic; said decision logic including a repository for storing a plurality of buy/sell rules for buying and selling securities in response to said buy and sell data, said market news data, and said model trader order and execution data with said clock times; said decision logic having a plurality of agents, each assigned a respective buy/sell rule for generating buy/sell orders for securities in conformance with model trader behavior; said agents having outputs communicating with said securities exchange or a trade simulation module for executing said buy/sell orders, the method comprising the steps of:
(a) issuing to all agents a tentative buy short/sell long order for a given security;
(b) soliciting from all agents a tentative buy short decision of a given security;
(c) affirming with the decision logic the buy short decision if a majority of the agents have indicated an affirmative buy short decision;
(d) executing with an executing logic the affirmed buy short order; and having artificial intelligence based on a feedback system wherein, after executed transactions, the agents are given added or reduced voting power in accordance with the respective success or failure of said transactions based on recommendations of the respective agents.
